(19) United States
(12) Patent Application Publication
(10) Pub. No.: US 2015/0049381 A1
(43) Pub. Date: Feb. 19, 2015

(54) IMAGE MEASURING APPARATUS

(71) Applicants: HONG FU JIN PRECISION INDUSTRY (ShenZhen) CO., LTD ., Shenzhen (CN); HON HAI PRECISION INDUSTRY CO., LTD., New Taipei (TW)

(72) Inventors: CHIH-KUANG CHANG, New Taipei (TW); LI JIANG, Shenzhen (CN); DONG-HAI LI, Shenzhen (CN)

(73) Assignees: HONG FU JIN PRECISION INDUSTRY (ShenZhen) CO., LTD ., Shenzhen (CN); HON HAI PRECISION INDUSTRY CO., LTD., New Taipei (TW)

(21) Appl. No.: 14/252,512

(22) Filed: Apr. 14, 2014

(30) Foreign Application Priority Data
Aug. 19, 2013 (CN) 2013205047537

(51) Int. Cl. G02B 21/26; G02B 21/00

(52) U.S. Cl. CPC G02B 21/26; G02B 21/0016
USPC 359/384

(57) ABSTRACT

Image measuring apparatus configured to measure dimensions of a work piece includes a base, a measuring stage, a supporting portion, an adjusting portion, and a microscope. The measuring stage is configured to place and secure the work piece on the base. The supporting portion is secured to the base. The adjusting portion and the microscope are assembled to the supporting portion. When the adjusting portion is rotated, the adjusting portion drives the supporting portion to slide along a longitudinal direction so that the microscope moves relative to the measuring stage.

### FIELD

The disclosure generally relates to image measuring apparatuses, and particularly to an omnidirectional image measuring apparatus having a relative small volume.

### BACKGROUND

An image measuring apparatus is a kind of equipment which measures dimensions, assembly positions, and forms (i.e. contour or shape) error of work pieces by microscope measurement technology. The image measuring apparatus can display the measured work pieces, and can also quickly generate related measuring images of the measured work pieces by computers.

To omnidirectionally measure the work pieces, the image measuring apparatus commonly employs a three-dimensional moving structure to drive a microscope to move relative to the work pieces in three-dimensional directions (for example X, Y, and Z directions).

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is an isometric view of an image measuring apparatus, according to an exemplary embodiment of the disclosure.

FIG. 2 is a partial isometric view of the image measuring apparatus of FIG. 1 without a first shield and a second shield.

FIG. 3 is a partially disassembled view of the image measuring apparatus of FIG. 1.

FIG. 4 is a partial isometric view of the image measuring apparatus of FIG. 1.

FIG. 5 is an isometric view of a support portion of the image measuring apparatus of FIG. 1.

### DETAILED DESCRIPTION

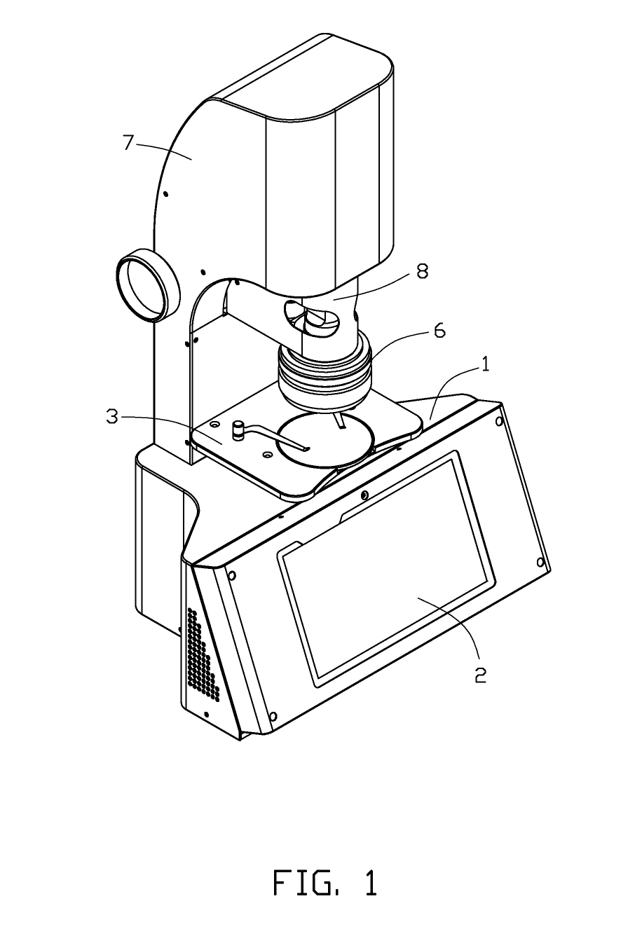

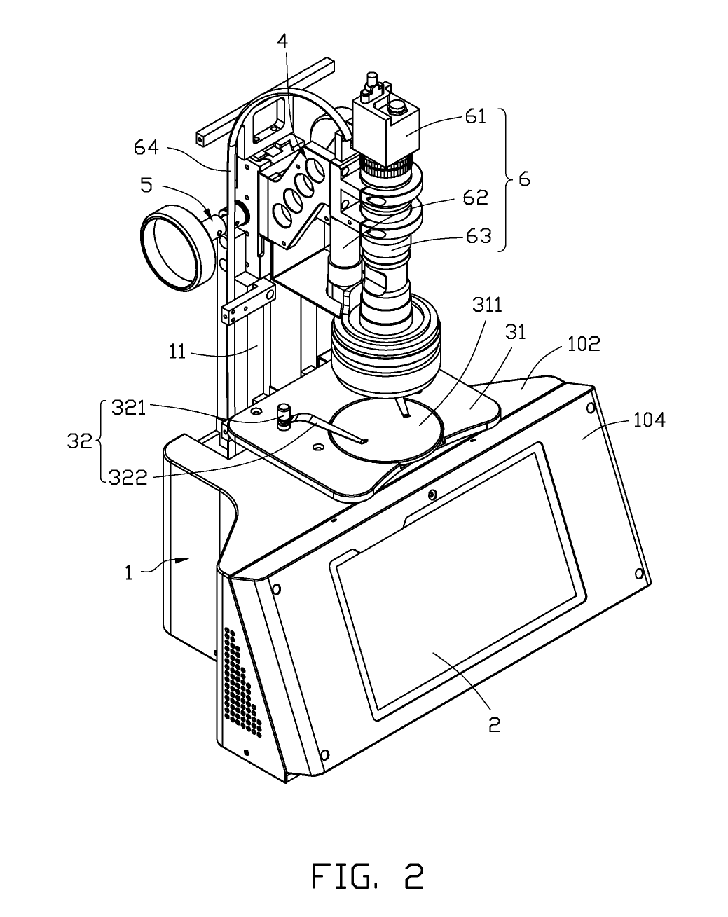

FIG. 1 is an isometric view of an image measuring apparatus, according to an exemplary embodiment of the disclosure. Also referring to FIG. 2, the image measuring apparatus includes a base 1, a computer 2, a table 3, a supporting portion 4, an adjusting portion 5, a measuring portion 6, a first shield 7, and a second shield 8.

The table 3 and the supporting portion 4 can be secured to the base 1. The table 3 is configured to place and fasten a work piece. The adjusting portion 5 and the measuring portion 6 are assembled to the supporting portion 4. The adjusting portion 5 is configured to adjust a distance between the measuring portion 6 and the table 3. The second shield 8 covers the measuring portion 6. The first shield 7 covers the supporting portion 4, the adjusting portion 5, and a portion of the second shield 8.

The base 1 includes a top surface 102 and a mounting surface 104. The mounting surface 104 is connected to the top surface 102 and defines an inclined angle relative to the top surface 102. A circuit board (not shown) is received inside the base 1. A power switch (not shown) and a power interface (not shown) are positioned on a back surface of the base 1 opposite to the mounting surface 104. The base 1 further includes a fixing frame 11 formed by two posts. The fixing frame 11 is positioned on one side of the top surface 102 opposite to the mounting surface 104.

The computer 2 is positioned on the mounting surface 104 and electronically connected to the circuit board inside the base 1. The computer 2 is also electronically connected to the measuring portion 6 by the circuit board.

The table 3 includes a measuring stage 31 and two latching members 32. The measuring stage 31 is substantially a plate including a circular stage portion 311 adjacent to the mounting surface 104. The stage portion 311 is rotatable relative to the measuring stage 31. Each latching member 32 includes a fixing post 321 and an elastic clip 322. The fixing post 321 protrudes from the measuring stage 31. A first end of the elastic clip 322 is secured to the fixing post 321. A second end of the elastic clip 322 is configured to press the work piece toward the stage portion 311.

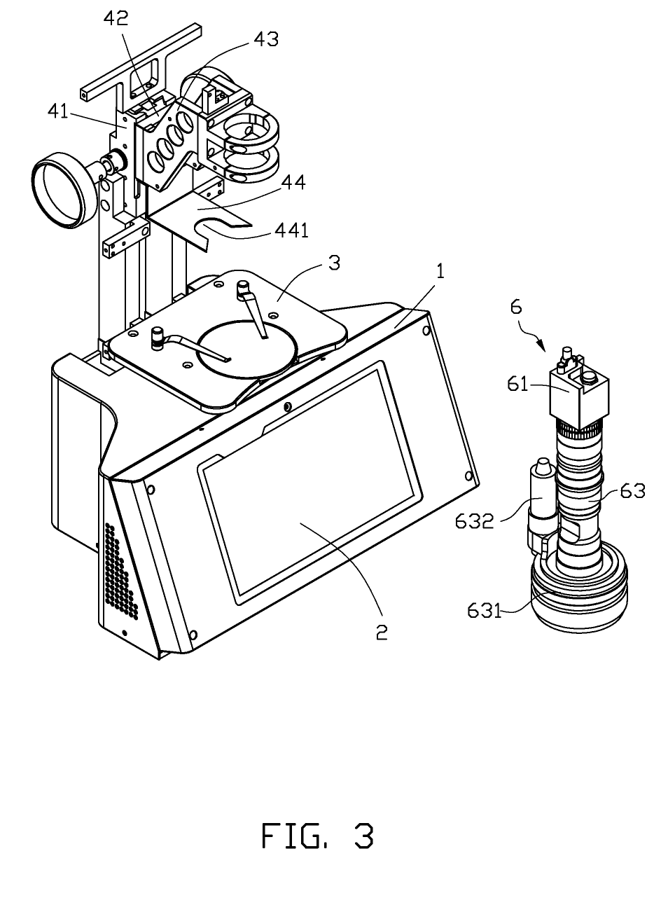

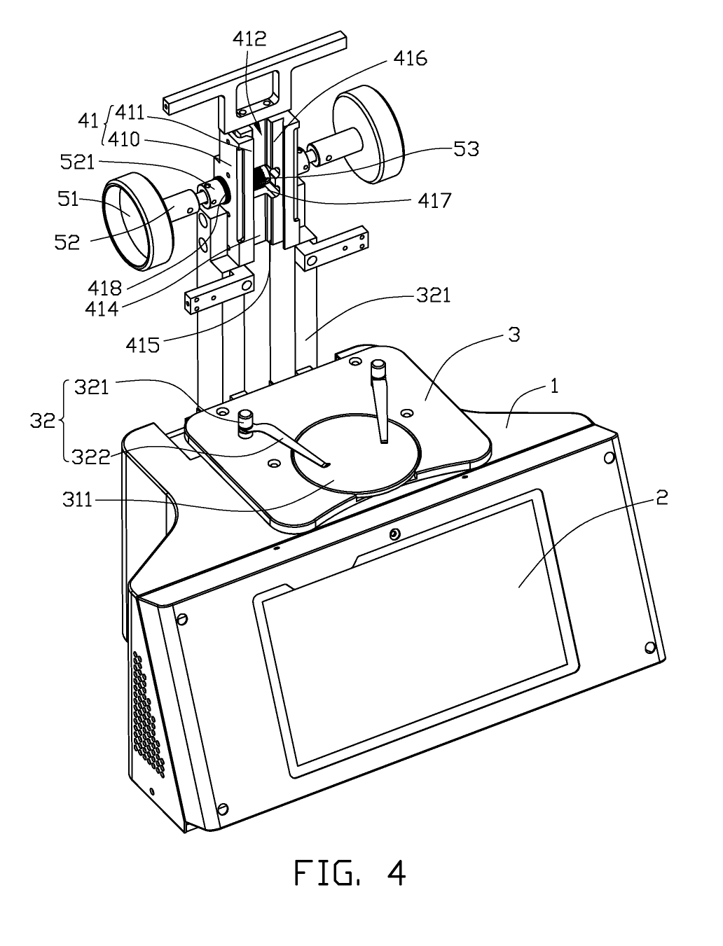

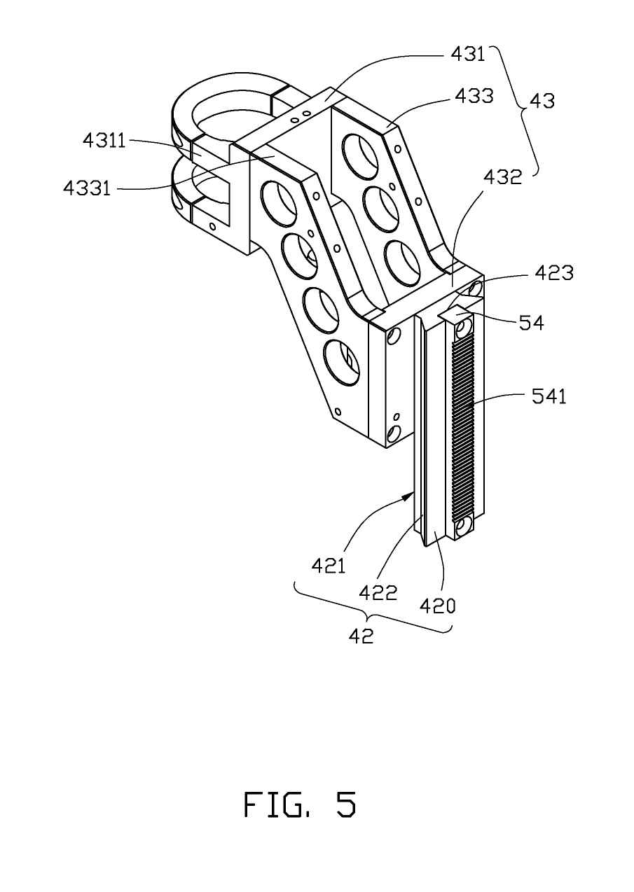

FIGS. 3 and 4 illustrate that the supporting portion 4 includes a mounting block 41, a sliding block 42, a supporting frame 43 (see FIG. 5) and an extending board 44. The mounting block 41 includes two opposite first side surfaces 410 and a second side surface 411 interconnecting the first side surfaces 410. The first side surfaces 410 are fixed to the fixing frame 11. A strip-shaped through slot 412 is longitudinally defined in the second side surface 411. A bottom wall 414 and two opposite side walls 415 are formed in the mounting block 41 surrounding the through slot 412. A sliding slot 416 is defined in each side wall 415. A receiving slot 417 is defined in the bottom wall 414. A mounting hole 418 is defined in each first side surface 410. The mounting holes 418 communicate with the receiving slot 417.

FIG. 5 illustrates that the sliding block 42 is a substantially strip-shaped block having a substantially trapezoidal cross-section. The sliding block 42 includes a first surface 420 and a second surface 421 opposite to the first surface 420. A sliding rail 422 is formed between the first surface 420 and the second surface 421. A substantially strip-shaped groove 423 is longitudinally defined in a middle portion of the first surface 420. The sliding block 42 is received in the through slot 412 with the sliding rails 422 assembled in the sliding slots 416.

The supporting frame 43 includes a mounting plate 431, a fixing plate 432 and two supporting arms 433. The mounting plate 431 and the fixing plate 432 are substantially rectangular and parallel to each other. Each supporting arm 433 is substantially a Z-shaped plate including two end portions 4331. One end portion 4331 of each supporting arm 433 is secured to a first surface of the mounting plate 431. The other one end portion 4331 of each supporting arm 433 is secured to a first surface of the fixing plate 4321. Two latching rings 4311 can be spaced from each other and protrude from a second surface of the mounting plate 431 opposite to the supporting arms 433. A second surface of the fixing plate 432 opposite to the supporting arms 433 is secured to the second surface 421 of the sliding block 42.

The extending plate 44 (see FIG. 3) is secured to the mounting block 41 and positioned between the supporting frame 43 and the measuring stage 31. A latching hole 441 is defined in the extending plate 44.

The adjusting portion 5 includes two handles 51, a rotating shaft 52, a gear 53, and a rack 54 (see FIG. 5). The gear 53 is received in the receiving slot 417. Two bearings 521 are sleeved around the rotating shaft 52. The bearings 521 are received in the mounting holes 418. The rotating shaft 52 is extended through the mounting holes 418 and the receiving slot 417 with the gear 53 sleeved around the rotating shaft 52 and positioned between the bearings 521. The handles 51 are positioned at two ends of the rotating shaft 52. The rack 54 is received in the groove 423. A plurality of evenly spaced teeth 541 protrude from the rack 54. A distance between every two teeth 541 is about 1 mm. A distance between the two teeth 541 at two ends of the rack 54 is about 80 mm.

FIG. 3 illustrates that the measuring portion 6 includes an image sensor 61, and a three-dimensional microscope 63. The image sensor 61 can be a CCD image sensor. The image sensor 61 is secured to one end of the microscope 61 and is electronically connected to the circuit board by a cable 64. The microscope 63 releaseably attached to the supporting portion 4. The microscope 63 includes a drawtube 631 and a motor 632. The motor 632 is positioned at one side of the drawtube 631 and configured to drive the drawtube 631 to rotate. The microscope 63 is latched in the latching rings 4311 (see FIG. 5) facing the stage portion 311. The microscope 63 is configured to capture images of the work piece. The image sensor 61 converts the images into digital information and transmits the digital information to the computer 2.

In assembly, the rack 54 is received in the groove 423. The sliding block 42 is assembled to the mounting block 41 with the teeth 541 engaging with the gear 53 and the sliding rails 422 received in the sliding slots 416 respectively. The supporting frame 43 is secured to the sliding block 42 by fixing the fixing plate 432 to the sliding block 42. The motor 62 is latched in the latching rings 4311.

To adjust the distance between the microscope 63 and the measuring stage 31, the handles 51 are manually operated to rotate the rotating shaft 52 so that the gear 53 rotates and slides on the teeth 541. The rack 54 is driven to shift in an up and/or down direction. The sliding block 42 slides along the sliding slots 416. The microscope 63 is secured to the support frame 43 but also moves along an up and/or down direction (i.e. a longitudinal direction) relative to the base 1 until the microscope 63 reaches a desired position. The motor 62 relative to the work piece can rotate the microscope 63. Therefore, the work piece can be omnidirectionally measured.

The image measuring apparatus without a complex three-dimensional structure can adjust the distance between the microscope 63 and the measuring stage 31 by operating the adjusting portion 5. Thus, the image measuring apparatus has a relative smaller volume.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An image measuring apparatus configured to measure dimensions of a work piece, the image measuring apparatus comprising:
a base;
a measuring stage configured to carry the work piece and mounted to the base;
a supporting portion mounted to the base;
an adjusting portion assembled to the supporting portion; and
a microscope releaseably attached to the supporting portion; wherein when the adjusting portion is rotated and drives the supporting portion to slide along a longitudinal direction so that the microscope moves relative to the measuring stage.

2. The image measuring apparatus of claim 1, wherein the supporting portion comprises a mounting block and a sliding block assembled to the mounting block; the mounting block defines a receiving slot; the adjusting portion comprises a gear having a plurality of teeth, a rack and a rotating shaft, the gear is sleeved around the rotating shaft, the shaft is extended through the receiving slot and the gear is receiving slot, the rack is received in the sliding block, and engages with the gear; the supporting portion is secured to the sliding block; when the rotating shaft is rotated, the gear rotates and slides on the teeth so that the sliding block drives the supporting portion to slide along an up and down direction.

3. The image measuring apparatus of claim 2, wherein the mounting block further comprises a through slot and forms a bottom wall and two side wall surrounding the slot, the bottom wall defines the receiving slot, each side wall defines a sliding slot; the sliding block comprises a first surface, a second surface opposite to the first surface, and two sliding rails form between the first surface and the second surface; the sliding rails engage with the sliding slots.

4. The image measuring apparatus of claim 3, wherein the supporting portion further comprises a supporting frame, the supporting frame comprises a mounting plate, a fixing plate and two supporting arms, the mounting plate and the fixing plate are parallel to each other, each supporting arm comprises two end portions, one end portion of each supporting arm is secured to a first surface of the mounting plate, the other one end portion of each supporting arm is secured to a first surface of the fixing plate; a second surface of the mounting plate is secured to the sliding block.

5. The image measuring apparatus of claim 4, wherein the supporting portion further comprises at least one latching ring protruding from a second surface of the mounting plate opposite to the supporting arms, the microscope is latched in the latching ring.

6. The image measuring apparatus of claim 1, wherein the measuring stage comprises a stage portion configured to place the work piece and at least one latching member configured to fix the work piece, the stage portion is rotatable relative to the measuring stage.

7. The image measuring apparatus of claim 6, wherein the at least one latching member comprises a fixing post and an elastic clip; the fixing post protruded from the measuring stage; a first end of the elastic clip is secured to the fixing post, and a second end of the elastic clip is configured to press the work piece toward the stage portion.

8. An image measuring apparatus configured to measure dimensions of a work piece, the image measuring apparatus comprising:
a base;
a measuring stage configured to carry the work piece and mounted to the base;
a supporting portion secured to the base;
an adjusting portion assembled to the supporting portion; and
a microscope assembled to the supporting portion; wherein the adjusting portion is rotated and drives the supporting portion to slide in a longitudinal direction so that the microscope moves relative to the measuring stage in the up and down direction, the microscope comprises a drawtube and a motor positioned at one side of the drawtube, the motor is configured to drive the drawtube to rotate relative to the measuring stage.

9. The image measuring apparatus of claim 8, wherein the supporting portion comprises a mounting block and a sliding block assembled to the mounting block; the mounting block defines a receiving slot; the adjusting portion comprises a gear having a plurality of teeth, a rack and a rotating shaft, the gear is sleeved around the rotating shaft, the shaft is extended through the receiving slot and the gear is receiving slot, the rack is received in the sliding block, and engages with the gear; the supporting portion is secured to the sliding block; when the rotating shaft is rotated, the gear rotates and slides on the teeth so that the sliding block drives the supporting portion to slide in an up and down direction.

10. The image measuring apparatus of claim 9, wherein the mounting block further comprises a through slot and forms a bottom wall and two side wall surrounding the slot, the bottom wall defines the receiving slot, each side wall defines a sliding slot; the sliding block comprises a first surface, a second surface opposite to the first surface, and two sliding rails formed between the first surface and the second surface, the sliding rails engage with the sliding slots.

11. The image measuring apparatus of claim 10, wherein the supporting portion further comprises a supporting frame, the supporting frame a mounting plate, a fixing plate and two supporting arms, the mounting plate and the fixing plate are parallel to each other, each supporting arm comprises two end portions, one end portion of each supporting arm is secured to a first surface of the mounting plate, the other one end portion of each supporting arm is secured to a first surface of the fixing plate; a second surface of the mounting plate is secured to the sliding block.

12. The image measuring apparatus of claim 11, wherein the supporting portion further comprises at least one latching ring protruding from a second surface of the mounting plate opposite to the supporting arms, the microscope is latched in the at least one latching ring.

13. The image measuring apparatus of claim 9, wherein the measuring stage comprises a stage portion configured to place the work piece and at least one latching member configured to fix the work piece, the stage portion is rotatable relative to the measuring stage.

14. The image measuring apparatus of claim 13, wherein the at least one latching member comprises includes a fixing post and an elastic clip; the fixing post protruded from the measuring stage; a first end of the elastic clip is secured to the fixing post, and a second end of the elastic clip is configured to press the work piece toward the stage portion.
